(19) United States
(12) Patent Application Publication
(10) Pub. No.: US 2005/0159902 A1
(43) Pub. Date: Jul. 21, 2005

(54) Apparatus for library searches in mass spectrometry

(76) Inventors: Izumi Ogata, Ishioka (JP); Shinya Ito, Hitachinaka (JP); Yasuhiro Takegawa, Sapporo (JP); Kisaburo Deguchi, Sapporo (JP); Hiroaki Nakagawa, Sapporo (JP); Shin-Ichiro Nishimura, Sapporo (JP)

Correspondence Address: DICKSTEIN SHAPIRO MORIN & OSHINSKY LLP, 2101 L Street, NW, Washington, DC, 20037, US

(21) Appl. No.: 11/037,043

(22) Filed: Jan. 19, 2005

(30) Foreign Application Priority Data
Jan. 19, 2004 (JP) 2004-9977

(51) Int. Cl. G06F 19/00

(52) U.S. Cl. 702/30

(57) ABSTRACT

In a database MSⁿ spectrum search, search of a known compound whose principal chain is identical to that of an unknown compound is enabled, thereby allowing analysis of an entire structure even if the entire structures of the known compound in database and that of the measured unknown compound are not identical. The MSⁿ spectrum obtained in the MSⁿ measurement of the unknown compound is compared with all the MS^{m} spectra (m≧1) in the database regardless of MSⁿ generation. In the MSⁿ measurement of a series of related compounds including various types of different side chains of the same principal chain, such as in the case of biopolymers, it becomes possible to determine the structure of the principal chain using a database search even if the entire structure is not clear. And the estimation of the entire structure is made possible on the basis of the principal chain structure.

### BACKGROUND OF THE INVENTION

1. Field of the Invention

The present invention relates to a data processing apparatus for obtaining structural information regarding unknown compounds by searching for the mass spectra of such unknown compounds in a mass spectrum database of known compounds, the mass spectra of such unknown compounds being gained by using mass spectrometry that is capable of MSⁿ.

2. Background Art

In order to measure unknown compounds using mass spectrometry and to determine the structure thereof, a mass spectrum database of known compounds is widely used for searching for the mass spectrum of an unknown compound gained by measurement. JP Patent Publication (Kokai) No. 11-64285 A (1999) (Patent Document 1) and JP Patent Publication (Kokai) No. 2001-50945 A (Patent Document 2), for example, disclose mass spectrum database search methods.

Mass spectrometry uses an apparatus for separating and detecting a sample on the basis of the ratio of mass to charge (m/z), the sample being ionized using an ion source. In this case, a usual mass analysis method is referred to as MS¹, by which a sample ionized at the beginning using an ion source is detected as such. A method for obtaining a second mass spectrum is referred to as MS², by which the second mass spectrum is obtained by providing energy to ions (precursor ions) of a specific mass for fragmentation, the specific mass being in a mass spectrum obtained in MS¹, and by separating the masses of a plurality of generated product ions.

Each bond in a sample molecule has a different likelihood of cleavage in accordance with the structure of the relevant molecules. Thus, fragment ions in a mass spectrum gained in MS² have differing intensities, and show molecule-specific mass spectrum patterns. In other words, when different compounds show the same mass spectrum pattern in an MS¹ spectrum, they show different mass spectrum patterns in an MS² spectrum. Thus, more accurate identification is possible by searching the MS² spectrum along with the MS¹ spectrum using a database. JP Patent Publication (Kokai) No. 8-124519 A (1996) (Patent Document 3), JP Patent Publication (Kokai) No. 2001-249114 A (Patent Document 4), and U.S. Pat. No. 6,624,408 (Patent Document 5) show examples of a database search method using the MS² spectrum.

Conventionally, the object of database search for unknown compounds is to identify unknown compounds. Under such object, it is necessary that the unknown compounds and known compounds searched for in a database have the same molecular weight, so that it is meaningless to search for mass spectra whose generations are different (have different n values) to each other, when searching MSⁿ spectra. Thus, in conventional database search, among the MSⁿ spectra of unknown compounds and known compounds, mass spectra whose generations are the same, such as MS¹ for MS¹, MS² for MS² . . . are compared.
Patent Document 1: JP Patent Publication (Kokai) No. 11-64285 A (1999)
Patent Document 2: JP Patent Publication (Kokai) No. 2001-50945 A
Patent Document 3: JP Patent Publication (Kokai) No. 8-124519 A (1996)
Patent Document 4: JP Patent Publication (Kokai) No. 2001-249114 A
Patent Document 5: U.S. Pat. No. 6,624,408

### SUMMARY OF THE INVENTION

Generally, biopolymers such as carbohydrates and peptides, for example, have many series of related compounds including various types of different side chains at the same principal chain. In the structural analysis thereof, when the structure of the principal chain is determined in accordance with the MSⁿ spectrum of a cleaved principal chain, the analysis of the entire structure is possible by estimating the side chains on the basis of the structure of the principal chain, even if the entire structure is not clear. However, depending on compound, a series of related compounds has different numbers of MSⁿ generations (n) (FIG. 1) necessary to gain a mass spectrum pattern when a bond in the principal chain that shows the structure of the principal chain is cleaved in accordance with the number and types of bound side chains. Consequently, structural comparison that focuses on the principal chain has been impossible in conventional search methods by which, among MSⁿ spectra of each compound, mass spectra of the same generation are compared.

Also, compounds that have a multitude of structural isomers in which a plurality of structural units that have the same mass are bound, such as carbohydrates, have a multitude of isomers whose molecular weights are equivalent to one other. Thus, in many cases, although the same mass spectrum patterns are shown in MS¹, they result in different compounds. Consequently, it is difficult to accurately determine or identify structure via conventional database search methods.

It is an object of the present invention, in database searches for MSⁿ spectra, to enable searching for a known compound whose principal chain is identical to that of an unknown compound even if the entire structure of the known compound in a database and that of a measured unknown compound is not identical so as to readily analyze the entire structure.

In order to achieve the aforementioned object, the present invention provides a data processing apparatus for mass spectrometry. The data processing apparatus is capable of MSⁿ analysis of an ionized sample, and is provided with a database for storing mass spectrum data obtained as a result of MSⁿ analysis of known compounds by each compound, and for searching for the mass spectrum data by comparing the mass spectrum data with MS^{m} spectra (m≧1) obtained as a result of MS^{m} analysis of unknown compounds. The data processing apparatus is characterized in that it has a function of searching MSⁿ data involving differing generations, upon database search.

The MS^{m} spectrum of an unknown compound that is a comparison target in the present invention, is characterized in that the MS^{m} spectrum of the unknown compound is that with the smallest value of m among those mass spectra such that their intensity ratios of base ions to other ions are greater than a threshold.

The present invention is also characterized in that the MS^{m} measurement of unknown compounds ends when the intensity ratio of the base ions to other ions in the MS^{m} spectrum exceeds the threshold.

The present invention is further characterized in that the number m of mass spectra obtained as a result of the MS^{m} analysis of unknown compounds are compared with all the mass spectra in a database successively from m=1, depending on the structure of the database.

According to the present invention, in the MSⁿ measurement of a series of related compounds including various types of different side chains with the same principal chain, such as in the case of biopolymers, it is possible to determine the structure of the principal chain using a database search even if the entire structure is not clear. And the estimation of the entire structure is possible on the basis of the principal chain structure. Further, in a database search for determining the structure of a principal chain, it is possible to determine the structure of related compounds whose number is greater than that of known compounds registered in a database.

Moreover, in the MSⁿ measurement of compounds that have a structure where a plurality of structural units that have the same mass are bound and the molecular weights of isomers are equivalent to each other, it is possible to identify the isomers using a database search even if the mass spectrum patterns in the results of MS¹ are the same.

### BRIEF DESCRIPTION OF THE DRAWINGS

FIG. 1 shows conceptual diagrams of a database search method according to the present invention.

FIG. 2 shows a schematic diagram of mass spectrometry according to the embodiments of the present invention.

FIG. 3 shows diagrams of the structures of two types of sugar chains used in the embodiments of the present invention.

FIG. 4 shows mass spectra gained in MS² and MS³ analyses of the two types of sugar chains used in the embodiments of the present invention.

FIG. 5 shows a schematic diagram of the database search method in a first embodiment of the present invention.

FIG. 6 shows a diagram describing a data processing method in the first embodiment of the present invention.

FIG. 7 shows a schematic diagram of the database search method in a second embodiment of the present invention.

FIG. 8 shows a diagram describing the data processing method in the second embodiment of the present invention.

### DESCRIPTION OF THE PREFERRED EMBODIMENTS

In the following, the embodiments of the present invention are described.

### Embodiment 1

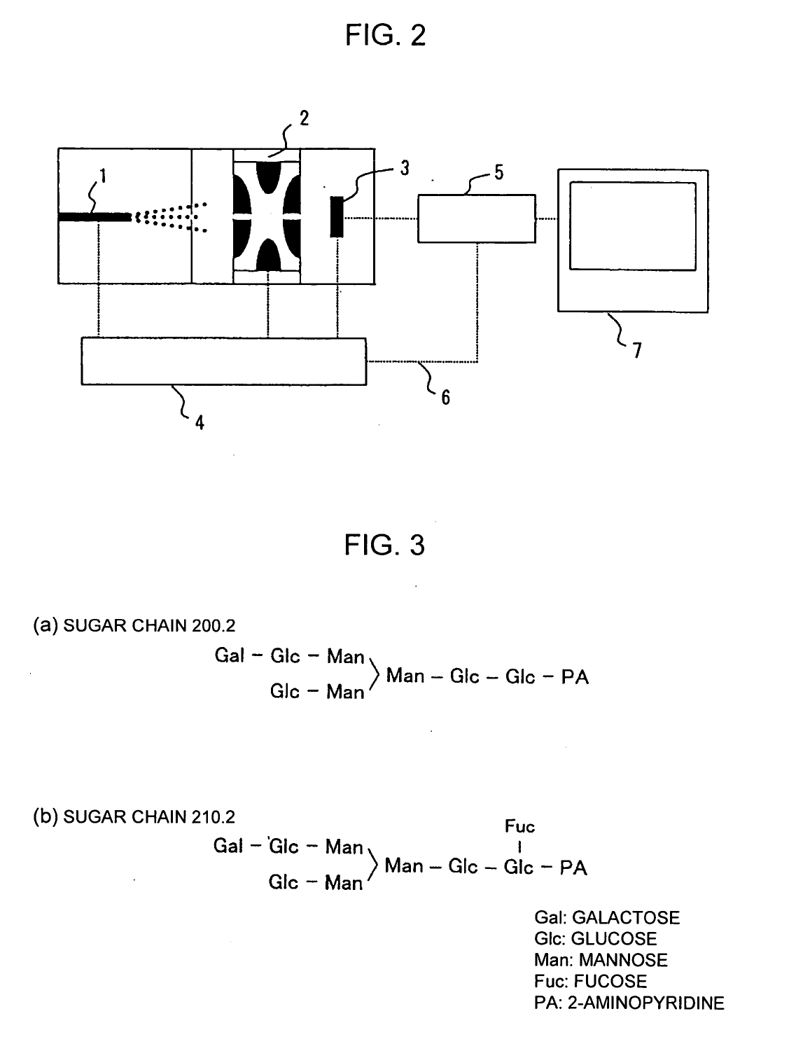

FIG. 2 shows the structure of mass spectrometry used in the embodiments of the present invention. The mass spectrometry according to the present invention comprises an ion source 1 for ionizing a sample, an ion trap type mass separating unit 2 for the mass separation of generated ions, the ion trap type mass separator being capable of MSⁿ, a detector 3 for detecting the mass-separated ions, controller 4 for the control thereof, a data processing unit 5, signal wires 6 for the connection thereof, and a display unit 7 for displaying measurement data and search results. The ion source 1 can employ a sonic spray ion source and an ion spray and a matrix-assisted laser desorption ion source, besides an electrospray source.

Sample ions ionized by the ion source 1 are introduced into the mass separating unit 2. In the mass separating unit 2, the sample ions are mass-separated. Also, MSⁿ (n=2, 3, 4 . . . ) is successively conducted in accordance with the setting performed by an observer. The mass-separated sample ions are sent to the detector 3 and detected in the form of a mass spectrum. The mass spectrum is sent to the data processing unit 5 for processing via the signal wire 6, and is displayed via the display unit 7.

FIG. 3 shows the structures of two types of sugar chains used in the present embodiment. On the basis of the nomenclature of Takahashi et al. described in Analytical Biochemistry, 1988, No. 171, page 73, these are referred to as 200.2 (FIG. 3a) and 210.2 (FIG. 3b). Although they have the same principal chains, sugar chain 210.2 has fucose (Fuc) bound to glucose (Glc) at the end thereof.

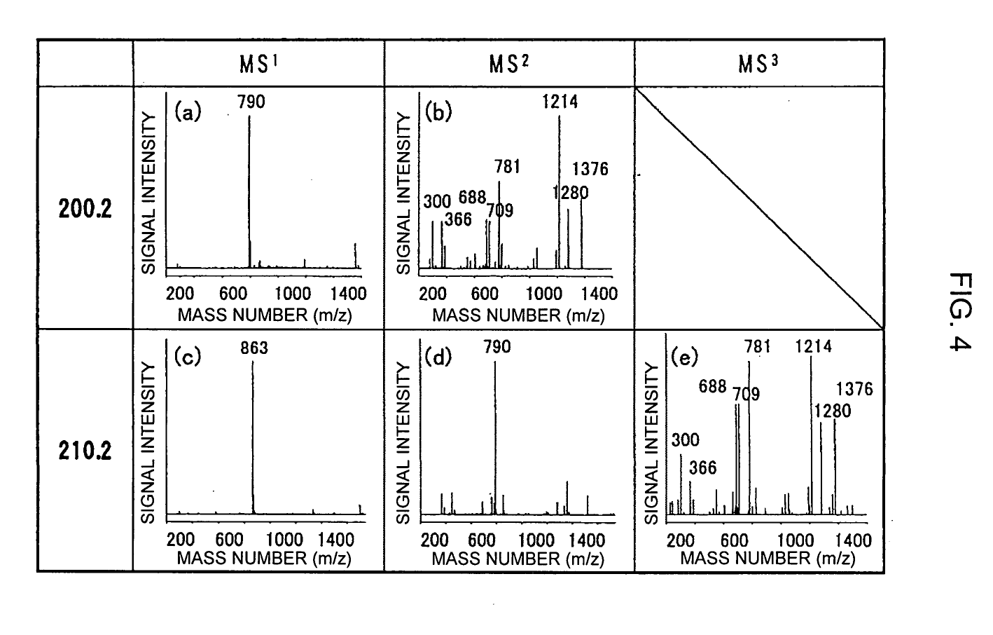

FIG. 4 shows the result of the MSⁿ analysis of the two types of sugar chains.

A sugar chain has a structure where a principal chain in which a multitude of sugars are bound is induced by various side chains. When the sugar chain is subjected to MSⁿ measurement, cleavage is caused successively from the bond between the principal chain and the side chains. Thus, the number of generations (n) for MSⁿ required for the bond in the principal chain to be cleaved differs depending on compounds. Also, the sugars constituting the principal chain of the sugar chain are isomers that have masses equivalent to one other, so that it is difficult to identify the structure of the principal chain on the basis of daughter ions corresponding to the principal chain, the daughter ions being gained by the desorption of the side chains upon MSⁿ⁻¹. Thus, it is necessary to conduct MSⁿ until the principal chain is cleaved.

In FIG. 4, charts (a) and (b) show the mass spectra of 200.2 in MS¹ and MS², and charts (c) to (e) show the mass spectra of 210.2 in MS¹ to MS³. In MS¹, only molecular ions are generated and only those molecular ions (m/z 790, 863) of 200.2 and 210.2 are detected (charts (a) and (c)). When MS² is conducted, in 200.2, each bond in the principal chain is cleaved and a plurality of fragment ions are generated (chart (b)). The generation pattern of the fragment ions shows structural information of the principal chain of 200.2. By contrast, in the MS² of 210.2, only the bond between the principal chain and the side chain (Fuc) is cleaved, so that only those daughter ions (m/z 790) corresponding to the principal chain are detected. Consequently, structural information about the principal chain cannot be obtained (chart (d)). When MS³ is further conducted concerning 210.2, each bond in the principal chain is cleaved and a plurality of fragment ions are generated (chart (e)). It is learned that the principal chains of 200.2 and 210.2 are the same in accordance with the similarity between the pattern of the MS³ spectrum showing structural information of the principal chain of 210.2 and the pattern of the MS² spectrum of 200.2.

In this case, when the MSⁿ measurement of unknown compounds is conducted, one method enables measurement allowing an observer to estimate sufficient n for the number of generations (n) of MSⁿ in advance such that it allows the principal chain of unknown compounds to be cleaved, and to specify n regarding measurement conditions.

Also, by setting a threshold for the intensity ratio of the base ions, which represent the strongest peak in a mass spectrum, to other ions in advance, it is possible to determine a mass spectrum in which the intensity ratio exceeds the threshold as a mass spectrum that shows structural information about the principal chain. On the basis of this, MSⁿ relative to the base ions can be automatically repeated until a mass spectrum that shows structural information about the principal chain can be obtained. For example, in the aforementioned case, measurement can be automatically conducted up to MS² in 200.2 and MS³ in 210.2 by establishing conditions whereby the principal chain is determined to be cleaved when the intensity of other ions exceeds 40% of the intensity of the base ions in a mass spectrum. A percentage from 10% to 50% is suitable for the threshold.

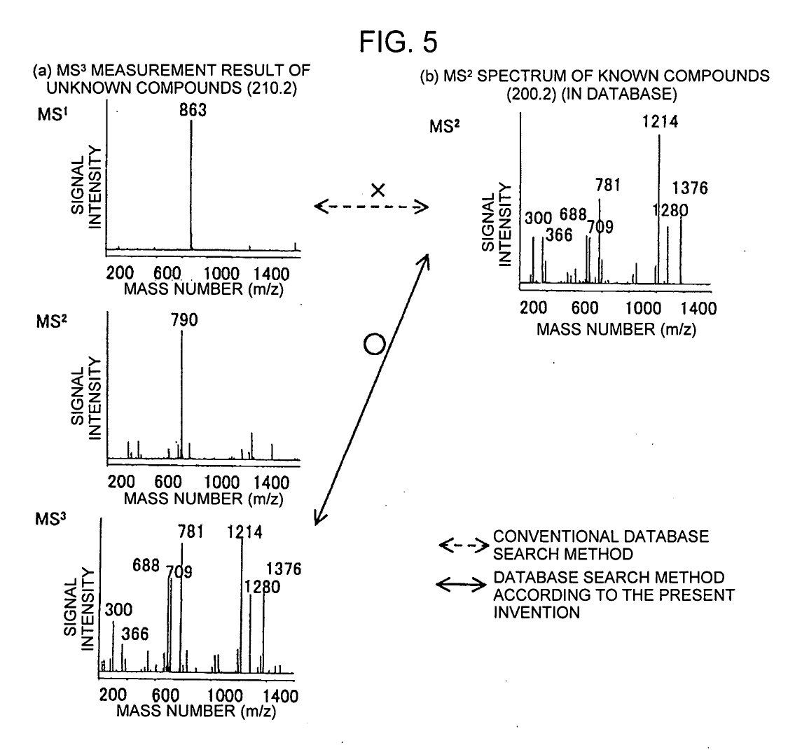

A case is considered where the MS² spectrum of 200.2 from data gained as mentioned above is registered in a database, and the results of MS³ analysis of 210.2 are searched for in the database (FIG. 5).

In the present invention, a mass spectrum that best shows structural information of the principal chain in the results of MS³ analysis of 210.2 is first selected from among the three mass spectra of MS¹, MS², and MS³.

This selection method has two methods regarding the MSⁿ analysis method for 210.2.

If measurement is conducted by specifying the number of MSⁿ generations (n) regardless of mass spectrum patterns, a mass spectrum that shows the structure of the principal chain is selected from the number n of gained mass spectra. The selection is carried out by determining a mass spectrum with the smallest n as the mass spectrum in which the principal chain is cleaved among mass spectra such that the intensity ratio of other ions to the base ions in the mass spectrum is not less than a certain threshold. In the case of 210.2, when the threshold is set as 40%, the MS³ spectrum in which the intensity of other ions to the base ions exceeds 40% is selected. A percentage from 10% to 50% is suitable for the threshold.

In contrast, if the MSⁿ measurement of 210.2 is conducted by automatically determining a mass spectrum in which the principal chain is cleaved, the mass spectrum that shows the structure of the principal chain is a mass spectrum gained as the end of the MSⁿ measurement; namely, the MS³ spectrum. Thus, it is selected.

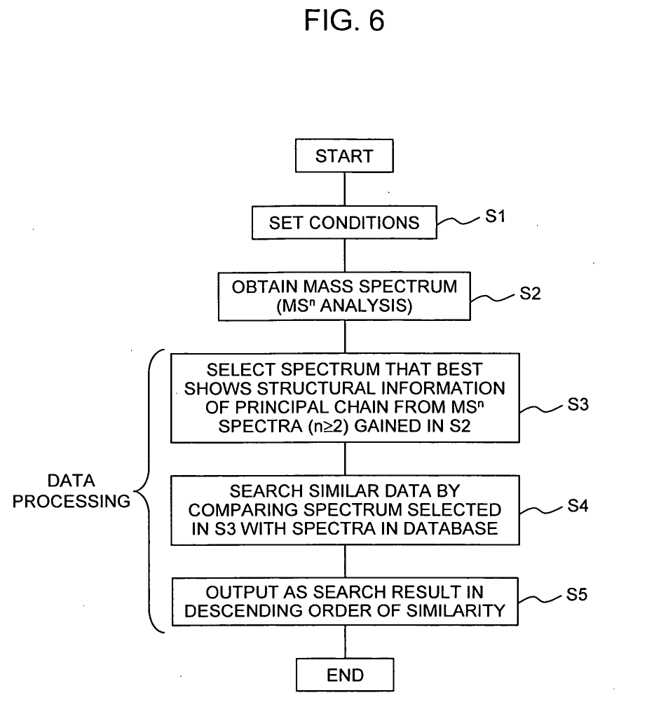

The selected MS³ spectrum is compared with all the mass spectra registered in the database. As a result, the MS² spectrum of 200.2 that shows a similar mass spectrum pattern is displayed as a search result, and the principal chain of 210.2 is determined to be the same as that of 200.2. An observer can analyze each mass spectrum of MS¹ and MS² using determined principal chain information, and can determine the entire structure (FIG. 6).

### Embodiment 2

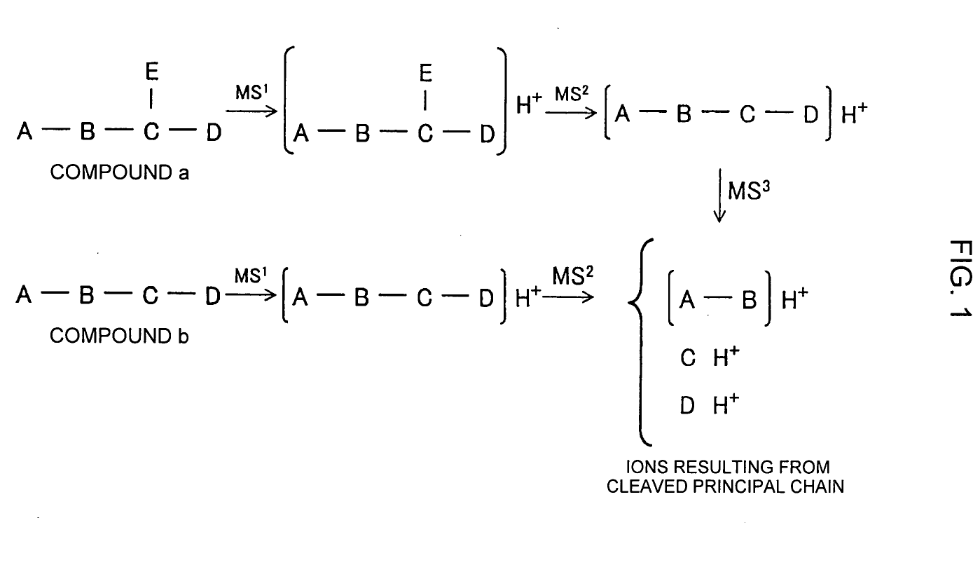

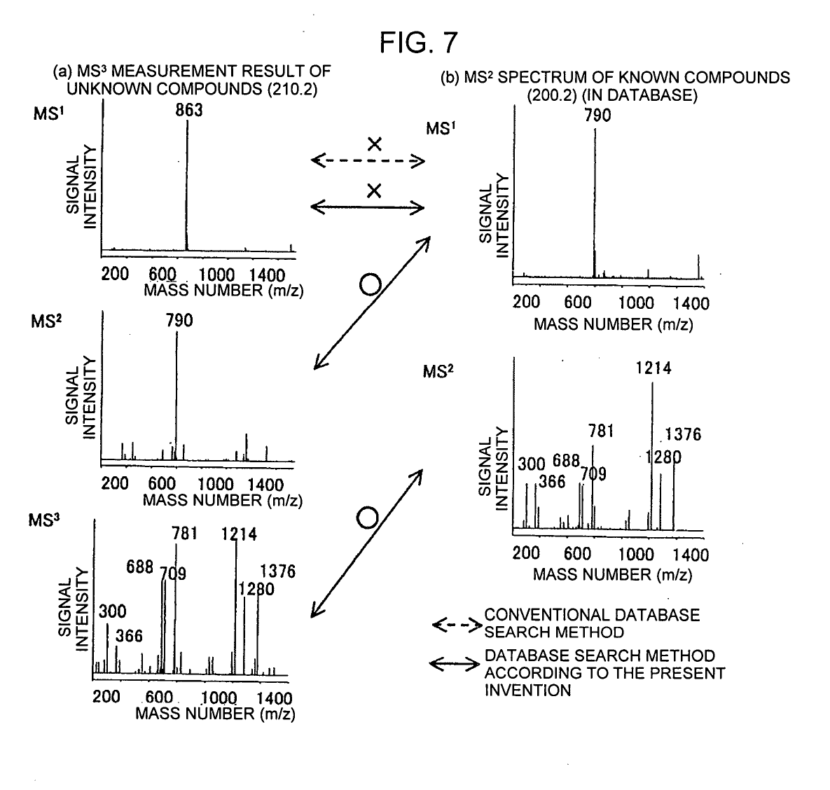

The second embodiment includes the constitution of the first embodiment shown in FIG. 1 and gained data of 200.2 and 210.2 shown in FIG. 4, and the database for storing MSⁿ spectra has a hierarchical structure such that n=1, 2, 3 . . . . Also, two mass spectra of MS¹ and MS² are registered in the database as a result of the MS² measurement of 200.2, and the results of the MS³ analysis of 210.2 are searched for in the database (FIG. 7).

In the present invention, an MSⁿ spectrum (n≧1) of 210.2 is first compared with all the mass spectra registered in the database successively from n=1 and any similar mass spectra are selected. In the present embodiment, the MS¹ spectrum of 200.2 that is similar to the MS² spectrum of 210.2 is selected. This comparison determines a mass spectrum that shows daughter ions corresponding to the principal chain.

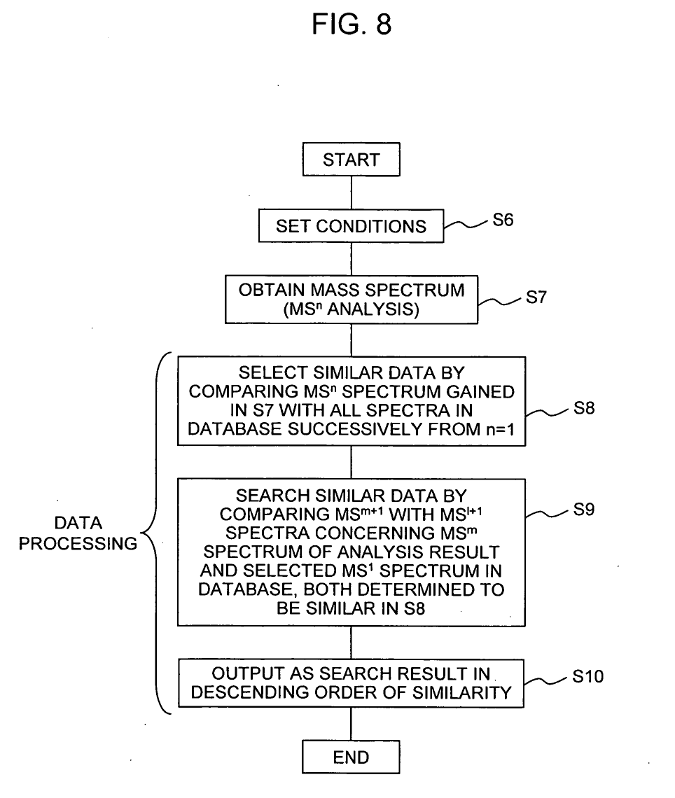

Then, concerning both a selected MS^{m} spectrum of an unknown compound and the MS¹ spectrum in the database, the MS^{m+1} spectrum and the MS¹⁺¹ spectrum are compared. In the present embodiment, the MS³ spectrum of 210.2 and the MS² spectrum of 200.2 in the database are compared. The comparison is conducted between the MS^{m} spectrum and the MSⁿ spectrum in which the base ions are cleaved. As a result, search results are displayed in descending order of similarity, and the principal chain of 210.2 is determined to be the same as that of 200.2 (FIG. 8).

Using determined principal chain information, an observer can determine the entire structure by analyzing each mass spectrum of MS² and MS¹.

1. A data processing apparatus for mass spectrometry that is capable of MSⁿ analysis of an ionized sample, said apparatus comprising a database in which mass spectrum data obtained as a result of the MSⁿ analysis of known compounds are stored on a compound by compound basis, wherein said database is searched based on a comparison between the mass spectrum data regarding the known compounds and the MS^{m} spectra (m≧1) obtained as a result of the MS^{m} analysis of an unknown compound,
said data processing apparatus for mass spectrometry further comprising a function enabling the search for MSⁿ data with different generations upon database search.

2. The data processing apparatus for mass spectrometry according to claim 1, wherein
said data processing apparatus performs ionization via an electrospray ionization method, a sonic spray ionization method with an ion spray, or a matrix-assisted laser desorption ionization method.

3. The data processing apparatus for mass spectrometry according to claim 1, wherein
the MS^{m} spectrum of the unknown compound that is a comparison target is that with the smallest value of m among those mass spectra with intensity ratios of base ions to other ions that exceed a threshold.

4. The data processing apparatus for mass spectrometry according to claim 3, wherein
the threshold for selecting the MS^{m} spectrum of unknown compounds, which is a comparison target, comprises an intensity ratio of from 10% to 50%.

5. The data processing apparatus for mass spectrometry according to claim 1, wherein
the MS^{m} measurement of unknown compounds ends when the intensity ratio of the base ions to other ions in the MS^{m} spectrum exceeds the threshold.

6. The data processing apparatus for mass spectrometry according to claim 5, wherein
the threshold for ending the MS^{m} measurement comprises an intensity ratio of from 10% to 50%.

7. The data processing apparatus for mass spectrometry according to claim 1, wherein
the number m of mass spectra obtained as a result of the MS^{m} analysis of unknown compounds are compared with all the mass spectra in the database successively from m=1.
